(19) United States
(12) Patent Application Publication
(10) Pub. No.: US 2026/0153838 A1
(43) Pub. Date: Jun. 4, 2026

(54) METHOD FOR SETTING THE RATE OF A REGULATING HOROLOGY ORGAN USING A LASER

(71) Applicant: ETA SA MANUFACTURE HORLOGÈRE SUISSE, Grenchen (CH)

(72) Inventors: Simon SPRINGER, Berne (CH); Sylvain HUOT-MARCHAND, Eschert (CH); Pascal WINKLER, St-Blaise (CH)

(73) Assignee: ETA SA MANUFACTURE HORLOGÈRE SUISSE, Grenchen (CH)

(21) Appl. No.: 19/387,899

(22) Filed: Nov. 13, 2025

(30) Foreign Application Priority Data
Dec. 3, 2024 (EP) 24217256.7

(51) Int. Cl. G04D 3/00; G04B 17/06

(52) U.S. Cl. CPC G04D 3/0069; G04B 17/06

(57) ABSTRACT

A method for setting the rate of a regulating organ (10) in a horology movement, the regulating organ (10) including an inertial mass (5), such as a balance, and resilient means (2) for returning the inertial mass (5), such as a balance spring, the resilient return means (2) being configured to enable the inertial mass (5) to carry out an oscillatory movement, the method including a step in which material is added to and/or removed from the inertial mass (5) by projecting material (9) using a laser (7).

### CROSS-REFERENCE TO RELATED APPLICATIONS

This application claims priority to European Patent Application No. 24217256.7 filed Dec. 3, 2024, the entire contents of which are incorporated herein by reference.

### TECHNICAL FIELD OF THE INVENTION

The invention relates to the field of horology, and more specifically to the field of mechanical watchmaking, in which the drive energy is regulated by a regulating organ.

The invention relates more specifically to a method for setting the rate of the regulating organ using a laser.

### TECHNOLOGICAL BACKGROUND

In most mechanical watches, the energy required to rotate the hands (for example, the minute and hour hands) is accumulated in a barrel, then dispensed by a sprung balance system, which comprises a flywheel called a balance, combined with a spring in the form of a strip wound into a spiral, called a balance spring

At an inner end, the balance spring is attached to an arbor that rotates with the balance; at an outer end, the balance spring is attached to a balance spring stud fitted on a stud holder, which is itself attached to a fixed bar (or cock).

The rotation of the balance is maintained-and its oscillations counted-by an escapement mechanism comprising a pallet driven by a low amplitude oscillating movement, provided with two pallets that engage the teeth of an escapement wheel. When thus engaged, the escapement wheel is forced into a step-by-step rotational movement at a frequency determined by the oscillation frequency of the pallet, which is itself set to the oscillation frequency of the sprung balance.

In a conventional escapement mechanism, the oscillation frequency is around 4 Hz, or approximately 28,800 vibrations/hour (A/h). Good horologists aim to ensure that the balance oscillates isochronously and steadily (meaning that the rate remains constant).

It is common practice to set the rate of the balance by adjusting the active length of the balance spring, defined as the curved length between its inner end and a measuring point located near the outer end of the balance spring and generally defined by a pair of stops carried by a key fitted on an index assembly.

The assembly comprising the bar, the index assembly, the key, the stud holder, balance spring stud, the arbor, the spring and the balance is commonly referred to as the “regulating organ.” Examples of regulating organs are provided by international application WO 2016/192957 and in European patent EP 2 876 504, both of which were granted to horology manufacturer ETA.

Another way of setting the rate of the balance is to change the inertia of the balance. Said inertia can be changed using radial screws and eccentric inertia blocks. By tightening or loosening one or more screws or eccentric inertia blocks, the inertia of the balance can be changed.

Other setting methods consist of adding or removing material from the balance to change its inertia. This enables the rate of the regulating organ to be set.

However, in most cases, a setting device needs to be built into the movement, which means that the configuration of the regulating organs needs to be significantly changed. These changes entail significant manufacturing and development costs.

Moreover, these setting devices require the case of the timepiece to be opened. Opening the case leads to pressure change issues, which have a negative impact on the measurement and setting of the rate.

### SUMMARY OF THE INVENTION

The present invention aims to remedy all or part of the drawbacks mentioned above by providing a method for setting the rate of a regulating organ that does not require major changes to the configuration of the regulating organ and that can be used to carry out this setting from outside a closed timepiece case.

To this end, the invention relates to a method for setting a regulating organ in a horology movement comprising an inertial mass, such as an annular balance, resilient means for returning the inertial mass, such as a balance spring, the resilient means being configured to enable the inertial mass to carry out an oscillatory movement.

A remarkable feature of the invention is that the method comprises a step in which material is added to and/or removed from the inertial mass by laser projection.

The invention provides a method for setting the rate of the regulating organ with a very high degree of precision, which has not been available to date. In addition, the movement does not have to undergo any major changes, as the components do not take up much space in the movement.

Furthermore, such a method can be used from outside a timepiece case, in particular by directing the laser through the case.

According to a particular embodiment of the invention, the laser removes material by removing material deposited in a layer beneath the inertial mass.

According to a particular embodiment of the invention, the inertial mass is transparent to the wavelength of the laser, so that the laser can pass through the inertial mass to the layer of fusible material.

According to a particular embodiment of the invention, the laser adds material from a support comprising the material deposited in a layer, the support being arranged above the inertial mass relative to the laser source.

According to a particular embodiment of the invention, the support is transparent to the wavelength of the laser.

According to a particular embodiment of the invention, the material is to be chosen among gold, platinum, tungsten, rhenium, rhodium, or iridium.

According to a particular embodiment of the invention, the deposition or removal step is carried out while the inertial mass is oscillating, with the laser being synchronised with the oscillation of the inertial mass.

According to a particular embodiment of the invention, the method comprises a preliminary step in which the oscillation frequency and/or amplitude of the inertial mass is measured and the deviation of the rate relative to a predetermined value is determined.

According to a particular embodiment of the invention, the oscillation frequency is measured optically using a camera, or acoustically using a microphone.

According to a particular embodiment of the invention, the step in which material is added to and/or removed from the inertial mass is carried out through the back of a timepiece case, the regulating organ being arranged in said case closed by said back, the back being transparent to the wavelength of the laser.

According to a particular embodiment of the invention, the step in which material is added to and/or removed from the inertial mass is carried out through the glass of the timepiece, the glass being transparent to the wavelength of the laser.

The invention also relates to a regulating organ for a horology movement, comprising an inertial mass, such as a balance, and resilient means for returning the inertial mass, configured to enable the inertial mass to carry out an oscillatory movement.

A remarkable feature of the regulating organ is that it comprises a first and a second component, the first component having at least a partial layer of fusible material, the first component being transparent to the wavelength of a laser capable of transferring the material to a second component.

According to a particular embodiment of the invention, the first component is the inertial mass on the regulating organ, and the second component is a support arranged below the inertial mass.

According to a particular embodiment of the invention, the first component is a support arranged above the inertial mass, and the second component is the inertial mass.

The invention also relates to a horology movement comprising such a regulating organ.

The invention further relates to a timepiece, for example a watch, comprising a case and such a horology movement arranged in the case.

According to a particular embodiment of the invention, the case is fitted with a back which is transparent to the wavelength of the laser.

### BRIEF DESCRIPTION OF THE FIGURES

The purposes, advantages and characteristics of the present invention will become apparent on reading several embodiments provided solely by way of non-limiting examples, with reference to the appended drawings in which:

FIG. 1 shows a schematic top view of a regulating organ from the prior art.

FIG. 2 shows a schematic side view of the regulating organ in FIG. 1, arranged in a horology movement.

FIG. 3 shows a schematic side view of part of a first embodiment of a regulating organ during the setting method according to the invention.

FIG. 4 shows a schematic side view of part of a second embodiment of a regulating organ during the setting method according to the invention.

FIG. 5 shows a schematic side view of part of a third embodiment of a regulating organ during the setting method according to the invention, and.

FIG. 6 shows a side view of a timepiece comprising a regulating organ during the setting method according to the invention.

### DETAILED DESCRIPTION OF THE INVENTION

The invention relates to a method for setting the rate of a regulating organ 1 in a horology movement.

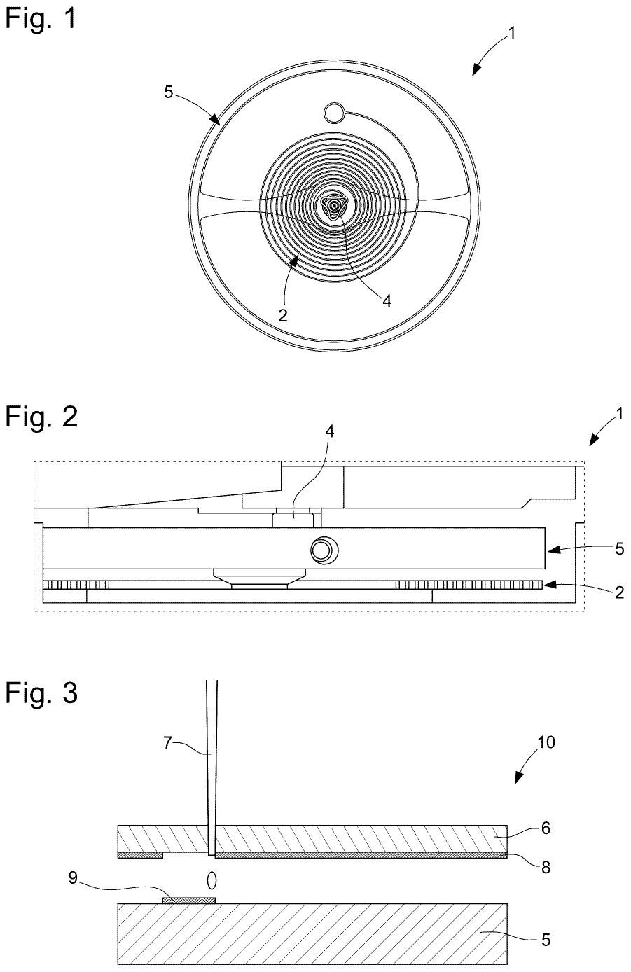

In FIGS. 1 and 2, such a regulating organ 1 comprises an inertial mass 5, such as a balance, and resilient means 2 for returning the inertial mass 5, for example a balance spring. The resilient return means 2 are configured to enable the inertial mass 5 to carry out an oscillatory movement. Such a regulating organ 1 needs to be able to be set in order to change the rate of the movement in which it is fitted.

According to the invention, the method comprises a step in which material is added to or removed from the inertial mass by laser projection.

For example, the material is projected using a LIFT (Laser Induced Forward Transfer) device.

This type of device uses a principle that involves targeting the material with a laser through a substrate on which the material is deposited in layers, in order to remove at least part of this material from the substrate and project it onto another body. Such a method is described in the following documents:
Printing Method for Long Flight Distance by Laser-Induced Forward Transfer, H. Suhara, J. Aoto, M. Iwata, Journal of Laser Micro/nanoengineering Vol 15, No 2, 2020,
Laser-Induced Forward Transfer: A high-resolution additive manufacturing technology, P. Delaporte, A-P. Alloncle, Optics & Laser Technology 78(2016 ) 33-41,
Laser-Induced Forward Transfer: A method for Printing Functional Inks, J.M. Fernandez-Pradas, P. Serra, and
Métallisation sélective de surfaces par voie laser [Selective metallisation of surfaces using lasers], A. Bahouka, Techniques de l'ingénieur [Engineering Techniques], 10 Dec. 2017, M 1 643 V2.

With this method, material can be added to or removed from the inertial mass 5 so as to change its inertial properties and thereby correct the rate of the regulating organ 1.

Indeed, adding or removing material from the inertial mass 5 changes its inertia, and thus its oscillation frequency. This induces a correction in the rate of the regulating organ.

FIG. 3 shows part of a first embodiment of a regulating organ 10 in which the method according to the invention can be used, in particular when adding material to the inertial mass 5.

When material is added to the inertial mass 5, it is added from a support 6 comprising the fusible material. In addition to the inertial mass 5, the regulating organ 10 comprises a support 6 for the fusible material.

The support 6 comprises a body that is transparent to the wavelength of the laser, and beneath which a layer 8 of material has been deposited. The transparent body is, for example, a synthetic sapphire such as Al₂O₃, silicon glass, quartz or monocrystalline silicon. The support 6 is arranged between the laser source and the inertial mass 5. The laser thus passes through the support 6 to the layer of material 8, such that pieces of material 8 come off the support 6 and land on the inertial mass 5.

Preferably, the distance between the support 6 and the inertial mass 5 is less than 10 mm, preferably less than 5 mm or even less than 2 mm.

The support 6 is, for example, a plate with a shape corresponding at least in part to that of the inertial mass 5.

Alternatively, the support 6 is a bar, for example a balance cock, on which the regulating organ 1 is fitted.

For example, the support 6 is driven in a balance cock, in which the regulating organ 1 is fitted.

Preferably, the material 9 is chosen among gold, platinum, tungsten, rhenium, rhodium or iridium.

For example, the laser has a frequency ranging from the infrared spectrum through the visible spectrum to the UV spectrum. The body of the support 6 is therefore transparent to the infrared spectrum and/or to the visible spectrum and/or to the UV spectrum. The wavelength of the laser is comprised between 350 and 1,100 nm, preferably between 500 and 1,000 nm, or even between 1,000 and 1,100 nm.

For example, the laser 7 is aimed at the upper face of the support 6 and passes through the transparent body to reach the layer 8 of material. Under the action of the laser 7, the material either melts or evaporates, or even comes off in pieces, depending on the laser and the material used.

This results in a projection of material 9, which is detached from the support 6 and deposited on the inertial mass 5. The laser 7 is moved along the layer 8 to transfer the desired amount of material onto the inertial mass 5. For example, the material is deposited on the circular part of the balance. As a result, the deposited material makes the balance heavier, thereby changing its oscillation frequency.

The support 6 can comprise several layers with different densities to make it easier to choose the amount of material to be transferred. As a variant, the support 6 can be replaced by several supports each with a layer of material with varying densities.

The support 6 can comprise a single layer 8 or a stack of layers to improve the adhesion of the transferred material to the inertial mass 5. For example, a layer of Au or Pt on a layer of Ti or Cr is used as an adhesion layer.

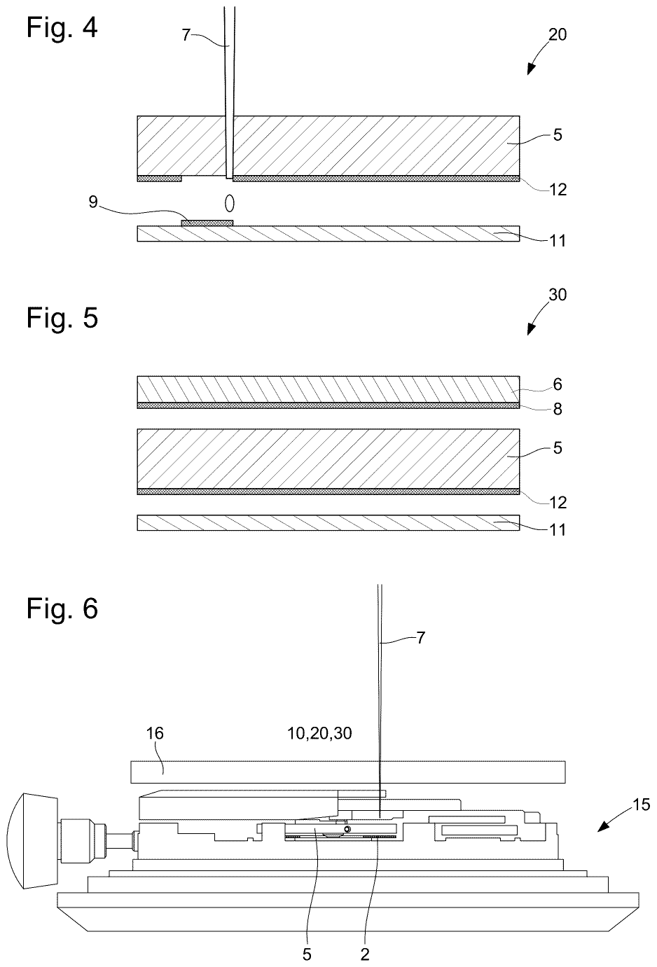

When material is removed using the laser 7, the material 9 deposited beneath the inertial mass 5 on the regulating organ 20 is removed, as shown in FIG. 4. Preferably, the inertial mass 5 comprises a body that is transparent to laser beams and beneath which a layer of material 12 has been deposited.

In this case, the laser 7 passes through the transparent body to reach the layer 12 of material deposited under the transparent body. Part of the material 9 in the layer 12 is projected onto a support 11 for the regulating organ 20, which is arranged under the inertial mass 5. Thus, in this variant of the method, the inertial mass 5 is lightened, such that its oscillation frequency is varied to set the rate of the regulating organ 20.

In FIG. 5, this embodiment combines the two previous embodiments so that material can be added to or removed from the inertial mass 5 as needed.

In this case, the regulating organ 30 comprises a first support 6 arranged above the inertial mass 5 and a second support 11 arranged below the inertial mass 5. The inertial mass 5 and the first support 6 each comprise a body transparent to the wavelength of the laser 7. In addition, they each comprise a layer of material 8, 12 deposited beneath the transparent body.

Preferably, the layers of material 8, 12 are not superimposed so the laser 7 can reach them separately.

Thus, by choosing to point the laser 7 at the first support 6 or at the inertial mass 5, material can either be added or removed from the inertial mass 5.

In this configuration, the inertia of the inertial mass 5 can be changed, either increased or decreased, to set the oscillation frequency of the balance.

In a first exemplary embodiment of the method, a nanosecond laser is used. The material is gold deposited on a sapphire support, while the balance is made of brass coated with a layer of CuBe.

Laser 7 is actuated in pulses with a duration, for example, comprised between 1 fs and 500 ns, preferably between 1 ns and 400 ns.

The fluence of the laser pulse is comprised between 0.1 and 100 J/cm², preferably between 0.5 and 50J/cm² , or even between 1 and 15J/cm².

The laser power is comprised between 5 W and 30 W, preferably between 10 W and 20 W.

The laser frequency is comprised between 50 kHz and 300 kHz, preferably between 150 kHz and 250 kHz, for example.

These parameters produce a lengthwise material deposit comprised between 0.05 μg/mm and 1 μg/mm for a width comprised between 20 and 80 μm.

A femtosecond laser can also be used, with a power comprised between 0.1 W and 2 W, preferably between 0.2 W and 1 W, but the layer obtained is spread out more. For example, the duration of the laser pulses is 260 fs.

The laser frequency is comprised between 10 kHz and 250 kHz, preferably between 150 kHz and 250 kHz.

For example, the material is gold arranged on a sapphire support. The result is a layer of material transferred to the brass balance.

Preferably, the position of the laser 7 can be changed relative to the support 6 and/or to the inertial mass 5. The laser 7 can then select zones in layers 8 and/or 12 that have not yet been impacted.

Preferably, the deposition or removal step is carried out when the inertial mass 5 is at a stop. In this case, the inertial mass 5 does not oscillate so as to facilitate the deposition or removal of material by the laser 7.

In a variant embodiment, the deposition or removal step is carried out while the inertial mass 5 is oscillating. To this end, the laser pulses are synchronised with the oscillation of the inertial mass 5.

Alternatively, the laser pulses are distributed over the entire oscillation period of the inertial mass 5 with no particular synchronisation.

Preferably, the method comprises a preliminary step for measuring the oscillation frequency and/or amplitude of the inertial mass 5. For example, the oscillation frequency is measured optically using a camera or acoustically using a microphone, such as a Witchi microphone, or by any other measurement method known to the person skilled in the art. Preferably, the oscillation frequency is measured in all four standard positions to correct any potential imbalance in the inertial mass 5.

The method also comprises a step in which the deviation in the rate from a predetermined value is determined. This determines the difference between the actual rate of the movement and the desired rate.

These two steps are used to determine the amount of material to be added to or removed from the inertial mass 5 to set the desired rate.

Furthermore, the step in which material is added to and/or removed from the inertial mass 5 can be carried out through the back 16 of a case (not shown in the figure) of a horology part, as shown in FIG. 6. The case comprises a horology movement 15 fitted with a regulating organ according to the invention.

The case is closed by a back 16, preferably detachable. To enable the laser 7 to pass through, the back 16 at least partially comprises a glass transparent to the wavelength of the laser 7.

This avoids having to open the case to change the rate of the regulating organ. The case comprises a bed for the horology movement, in which the regulating organ is arranged.

Naturally, the invention is not limited to the embodiments of the regulating organs described with reference to the figures, and variants could be envisaged without departing from the scope of the invention.

1. A method for setting the rate of a regulating organ in a horology movement, the regulating organ comprising an inertial mass and resilient means for returning the inertial mass, the resilient return means being configured to enable the inertial mass to carry out an oscillatory movement, wherein the method comprises a step in which material is added to and/or removed from the inertial mass by projecting material using a laser.

2. The setting method according to claim 1, wherein the laser removes material by removing material deposited in a layer beneath the inertial mass.

3. The setting method according to claim 2, wherein the inertial mass is transparent to the wavelength of the laser, so that the laser can pass through the inertial mass to the layer of material.

4. The setting method according to claim 1, wherein the laser adds material from a support comprising the material deposited in a layer, the support being arranged above the inertial mass relative to the laser source.

5. The setting method according to claim 4, wherein the support is transparent to the wavelength of the laser.

6. The setting method according to claim 1, wherein the material is to be chosen among gold, platinum, tungsten, rhenium, rhodium, or iridium.

7. The setting method according to claim 1, wherein the deposition or removal step is carried out while the inertial mass is oscillating, with the laser being synchronised with the oscillation of the inertial mass.

8. The setting method according to claim 1, further comprising a preliminary step in which the oscillation frequency and/or amplitude of the inertial mass is measured and the deviation of the rate relative to a predetermined value is determined.

9. The setting method according to claim 1, wherein the step in which material is added to and/or removed from the inertial mass is carried out through the back of a timepiece case, the regulating organ being arranged in said case closed by said back, the back being transparent to the wavelength of the laser.

10. A regulating organ for a horology movement, comprising an inertial mass, resilient means for returning the inertial mass, configured to enable the inertial mass to carry out an oscillatory movement, wherein the regulating organ comprises a first component with at least a partial layer of material, the first component being transparent to the wavelength of a laser capable of transferring the material to a second component.

11. The regulating organ according to claim 10, wherein the first component is the inertial mass on the regulating organ, and the second component is a support arranged below the inertial mass.

12. The regulating organ according to claim 10, wherein the first component is a support arranged above the inertial mass, and the second component is the inertial mass.

13. A horology movement, comprising the regulating organ according to claim 10.

14. A timepiece comprising a case and the horology movement according to claim 13, the horology movement being arranged in the case.

15. The timepiece according to claim 14, wherein the case is fitted with a back which is transparent to the wavelength of the laser.
